(19) United States
(12) Patent Application Publication
(10) Pub. No.: US 2007/0243500 A1
(43) Pub. Date: Oct. 18, 2007

(54) Method and Device(s) for Production of Dental Prostheses

(75) Inventors: Frank Uwe Stange, Langenargen (DE); Novica Savic, Ranstadt (DE); Karl-Heinz Renz, Frankfurt (DE)

Correspondence Address: Mark D. Marin;Norris McLaughlin & Marcus, PA, 875 Third Avenue, 18th Floor, New York, NY, 10022, US

(73) Assignee: HERAEUS KULZER GMBH, Hanau (DE)

(21) Appl. No.: 11/734,484

(22) Filed: Apr. 12, 2007

(30) Foreign Application Priority Data
Apr. 12, 2006 (DE) 10 2006 017 651.0

(51) Int. Cl. A61C 13/00

(52) U.S. Cl. 433/167

(57) ABSTRACT

Described is a method for producing a dental prosthesis, comprising the following steps: A Producing a model from a material which does not bond with the dental prosthesis material, B Fixing the teeth, C Filling the interspace between the artificial tooth/teeth and the model, wherein in step C melted thermoplastic material is applied in layers and after each layer is hardened by cooling.

The invention concerns methods and device(s) for production of dental prostheses.

Production of dental prostheses can occur in different ways. For example, the usual methods of powder/liquid technology, which have long been known and are described in the literature, can be mentioned (for example, EP 1243230 A2≈U.S. Pat No. 6,881,360B2 and Dental Materials, Ullmann s Encylcopedia of Industrial Chemistry, 2002 by Wiley-VCH Verlag). Three different main material classes are generally known for production of total prosthetic work. These are two-component materials based on polymethylmethacrylate (PMMA) (commercial products Palapress, Paladur (Heraeus Kulzer, Germany), SR 3/60® Quick (Ivoclar, Liechtenstein), Degupress® (Degussa-Hüls, Germany)); PMMA-free hot-curing materials (commercial products include Paladon® 65 (Heraeus Kulzer, Germany), SR 3/60®, SR Ivocap® (Ivoclar, Liechtenstein), Lucitone® (Dentsply, US)), as well as thermoplastically processable injection molding compounds.

The thermoplastic materials are heated and generally injected into a cavity via an injection molding method. A known method is “Polyapress®” which is marketed by Bredent, Senden (Germany), among others. There has been no lack of attempts to use polymers like PVC, polyurethane, polyamide or polycarbonate (see Ullmann's, 5.1.5 Other Denture Resins).

There are also methods based on light- or microwave-curing one-component materials (for example, Versyo.com® from Heraeus Kulzer) (see Ulllmann's, 5.1.3 Light-Cured Polymers and 5.1.4 Microwave-Cured Polymers).

A common feature of all these material is the work necessary for preparation of plastic processing.

Layer-buildup methods are also known from dental technology. They are generally used in conjunction with light-curing materials: for example, for trimming of metal crowns or to produce a prosthesis. Advantages in these methods are the control possible during the process and the possibility of color variation in order to obtain the most aesthetic possible dental work.

Rapid prototyping methods have also been proposed for use in the dental technology. Polymerizable layers (DE 10114290 A1, DE 10150256 A1) or ink jet powder printing (U.S. Pat. No. 6,322,728 B1) are then used.

It has surprisingly been found that a layered structure is also possible with thermoplastic materials.

The invention therefore concerns a method for production of a dental prosthesis with the steps
A Production of a model from a material not connected with the dental prosthesis material,
B Fixation of the teeth,
C Filling of the intermediate space between artificial tooth/teeth and model,
   in which molten thermoplastic material was applied in layers in step C and cured by cooling after each step.

Different ways are possible for execution:
1. Thermoplastic material is melted as a granulate in a corresponding handheld device and then directly applied by pressure through a nozzle. Application systems of this type are known from the application of hot melt adhesives.
2. Thermoplastic material is present in the form of a thread or wire with a diameter between 0.1 mm and 10 mm. Melting occurs by targeted heat introduction right before application. Transport of the thermoplastic thread expediently occurs unmelted in a flexible cable. It is applied through a nozzle, right in front of which a heating zone is situated, which causes melting of the material. An advantage in comparison with method 1 is mild treatment of the thermoplastic material. Damage to the material by the continuous effect of heat is thus prevented.
3. In a modification of method 2 the application nozzle can be fastened in a mechanically-controlled device. Application is fully automated here in a computer-aided manufacturing method.

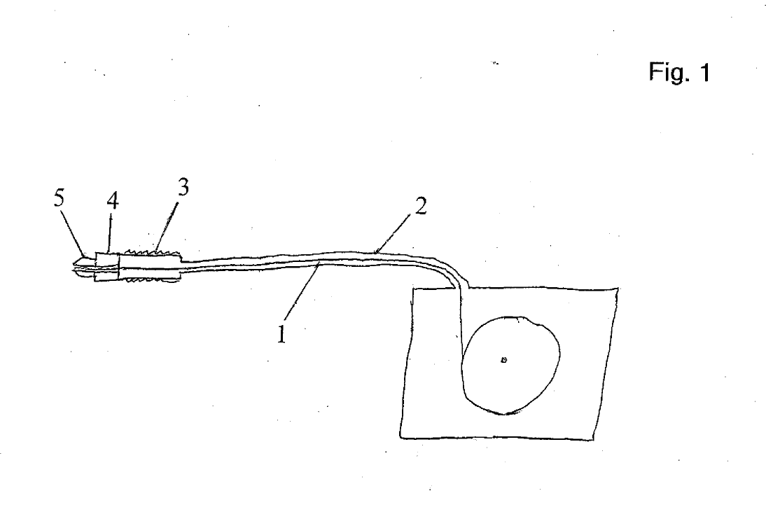

FIG. 1 shows a sketch of a device for execution of the method.

The invention also concerns a device for execution of the method with the aforementioned steps A, B and C with
a handle 3,
a device arranged on it to transport a plastic thread/wire 1 in a flexible cable 2,
a tubular heating zone 4 connected to the transport device to accommodate the plastic thread/wire,
an application nozzle 5 connected to the heating zone.

A computer-controlled moving arm can also be provided instead of the handle.

The invention correspondingly also concerns a method with the aforementioned steps A, B and C in which the thermoplastic material is present in the form of a thread 1 with a diameter between 0.1 mm and 10 mm, transport of the thermoplastic thread occur in flexible cable 2 and the thread is melted right before application by targeted introduction of the heat.

Production of prostheses can occur, in principle, with all thermoplastic materials. Materials with a low melt viscosity, like polyamide or polysulfone, are advantageous.

A particular advantage is rational production of a dental prosthesis. Skilled dental technicians are spared setup of the teeth (in wax), as is the case in the conventional process.

In addition to the described production of a dental prosthesis, use of the method for direct filling by the dentist during use of a low-melting thermoplastic (above 40° C. but below the temperature at which tissue damage occurs) is conceivable.

### EXAMPLE

Thermoplastic material is present in the form of a thread/wire 1 with a diameter between 0.1 mm and 10 mm. Melting occurs by targeted introduction of heat right before application. Transport of the thermoplastic thread/wire occurs unmelted in a flexible cable 2. In a handheld piece 3, which is connected to cable 2, heating zone 4 is mounted right in front of the application nozzle 5, which causes melting of the material.

The material is applied in layers and cured by cooling.

The teeth can be anchored in the material by two different methods:
1. The teeth are positioned beforehand and fixed with a mechanical holding device (for example Filou 28) or a mold material. The material is then allowed to flow around the positioned teeth and cool. The bond between the material and the artificial tooth can be chemical or purely mechanical.
2. The teeth are introduced and freely positioned during processing. A similar method is the now often practiced method of tooth setup in wax.

A prosthesis equivalent in function to a prosthesis produced conventionally was prepared according to 1.

What is claimed is:

1. A method for producing a dental prosthesis, comprising the following steps:
a) producing a model from a material which does not bond with an artificial tooth,
b) fixing at least one artificial tooth on the model; and
c) filling an interspace between the artificial tooth and the model with a plurality of layers of thermoplastic material, wherein each layer is formed by coating with melted thermoplastic material which is thereafter hardened by cooling.

2. The method according to claim 1, wherein in step B the fixing is achieved by use of a fixing device or an impression material.

3. The method according to claim 1 wherein the thermoplastic material is in the form of a granulate and is melted in a hand-held device, and under pressure is subsequently applied to the interspace directly via a nozzle.

4. The method according to claim 1 wherein the thermoplastic material is in the form of a thread having a diameter between 0.1 mm and 10 mm, the thermoplastic thread is transported to a point of application in a flexible cable and melted by the targeted introduction of heat prior to application.

5. A device for filling an interspace between an artificial tooth and a model comprising
a. a handle or a computer-controlled movable arm;
b. a transport apparatus provided thereon for transporting a plastic thread/wire in a flexible cable;
(c) a tubular heating zone adjoining the transport apparatus for accommodating the plastic thread/wire; and
(d) an application nozzle adjoining the heating zone.

6. The device according to claim 5, which comprises a computer-controlled movable arm.

7. The device according to claim 5, which comprises a handle.
